(19) United States
(12) Patent Application Publication
(10) Pub. No.: US 2024/0201934 A1
(43) Pub. Date: Jun. 20, 2024

(54) AUDIBLE GUIDANCE FOR CAMERA USERS

(71) Applicant: DELL PRODUCTS L.P., Round Rock, TX (US)

(72) Inventors: Seungjoo Choi, Singapore (SG); Seungjae Sung, Singapore (SG); Seong Yong Kim, Singapore (SG)

(21) Appl. No.: 18/349,713

(22) Filed: Jul. 10, 2023

(30) Foreign Application Priority Data
Dec. 15, 2022 (KR) 1020220176029

(51) Int. Cl. G06F 3/16; G06T 7/73

(52) U.S. Cl. CPC G06F 3/16; G06T 7/73; G06T 2207/30201

(57) ABSTRACT

An information handling system detects facial landmarks of a user based on a face detection learning model, and estimates a head pose of the user based on the detected facial landmarks. The system determines adjustment information based on the head pose of the user, and if the head pose of the user is rotated at an angle, then provides audible guidance based on the adjustment information.

### FIELD OF THE DISCLOSURE

The present disclosure generally relates to information handling systems, and more particularly relates to audible guidance for camera users.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system detects facial landmarks of a user based on a face detection learning model, and estimates a head pose of the user based on the detected facial landmarks. The system determines adjustment information based on the head pose of the user, and if the head pose of the user is rotated at an angle, then provides audible guidance based on the adjustment information.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIGS. 2-3 are diagrams illustrating a camera of an information handling system, according to an embodiment of the present disclosure;

FIGS. 4-5 are flowcharts illustrating a method for providing audible guidance for camera users, according to an embodiment of the present disclosure;

FIGS. 6-8 are full-screen views of a user of a videoconference application, according to an embodiment of the present disclosure;

FIGS. 9-11 are top views of a user relative to a display device, according to an embodiment of the present disclosure;

FIG. 12 is a diagram of a system configured with audible guidance for video camera users, according to an embodiment of the present disclosure; and

FIG. 13 is a flowchart illustrating a method for providing an audible guidance feature for a camera user, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

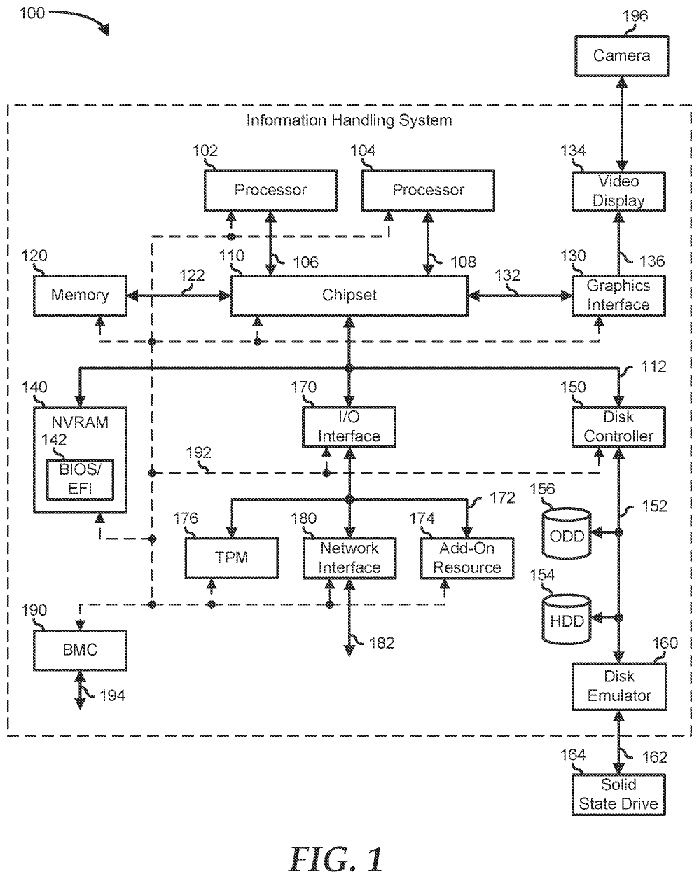

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, a baseboard management controller (BMC) 190, and a camera 196. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (x4) PCIe adapter, an eight-lane (x8) PCIe adapter, a 16-lane (x16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like. Camera 196 may be any device or apparatus that can capture visual images and communicates the visual images for use by information handling system 100, such as to support a videoconference, video meetings, teleconference, or similar. The visual images may include still and video images. Still images may include two-dimensional or three-dimensional images. Camera 196 may be a webcam or a video camera that can provide visual images to video display 134. For example, camera 196 may be a 4K camera, a high definition camera, an ultra high definition camera, or similar.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172 and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included at a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSS) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Peripheral cameras used in videoconferencing may be coupled with a clip or bracket to a top side of a peripheral display device so that the user viewing the display will appear to be looking at the camera. Some display devices integrate the camera into the display housing, including portable information handling systems, which integrate the camera through an opening in the housing bezel. During the videoconference, users tend to center their faces in a certain area so that the camera can capture a reasonable visual image. However, blind or visually impaired user cannot see how their face is shown in a video stream, and so typically rely on sighted users to provide feedback on their appearance. Thus, there is a need for a system and method that can provide auditory feedback to blind or visually impaired users regarding their appearance prior to or during the videoconference.

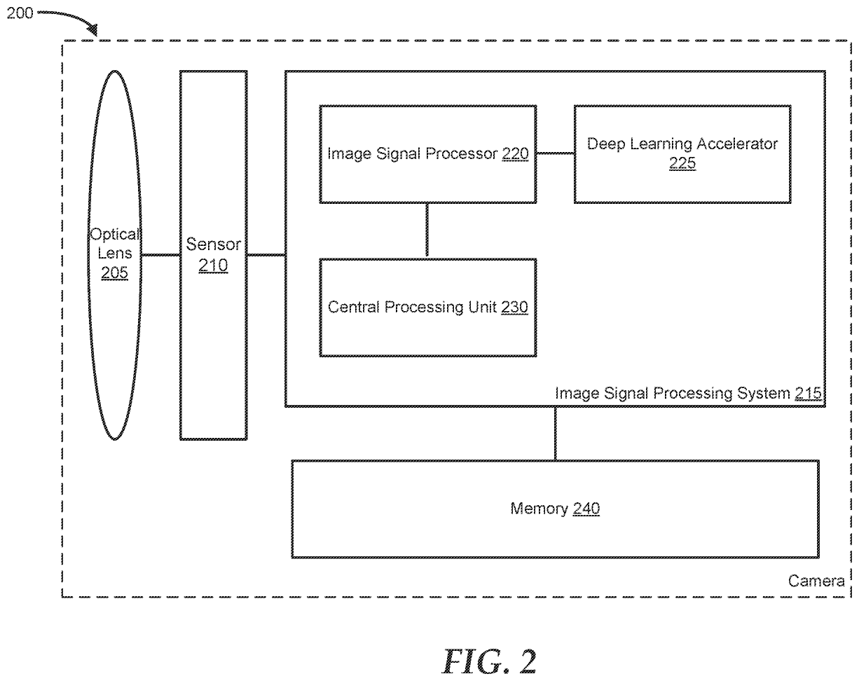

FIG. 2 shows a diagram of a camera 200 of an information handling system. Camera 200 is similar to camera 196 of information handling system 100 of FIG. 1. Camera 200 includes an optical lens 205, a sensor 210, an image signal processing system 215, and a memory 240. Image signal processing system 215 includes an image signal processor 220, a deep learning accelerator 225, and a central processing unit 230. Optical lens 205 may be communicatively coupled to sensor 210 which is communicatively coupled to image signal processing system 215. Image signal processing system 215 may be communicatively coupled to memory 240. The components of camera 200 may be implemented in hardware, software, firmware, or any combination thereof. The components shown are not drawn to scale and camera 200 may include additional or fewer components. In addition, connections between components may be omitted for descriptive clarity.

Optical lens 205 may be any suitable lens or apparatus configured to capture light or optical data. Sensor 210 may comprise any suitable system, device, or apparatus to receive and process the optical data from optical lens 205 and provide sensor data as an output. Image signal processing system 215 may be configured as a system-on-chip that can capture and process digital frames of image data or video data. Image signal processor 220 may process the sensor data into a final image. The sensor data may include raw camera images, three-dimensional depth indicators, user gaze, etc. Image signal processor 220 may process or tune the sensor data in a pipeline using various imaging algorithms to enhance images under various conditions. For example, image signal processor 220 may perform black level correction, lens shading correction, color correction tuning, low light enhancement, etc. Image signal processor 220 may transmit the final image to deep learning accelerator 225. Image signal processor 220 may process or tune the sensor data with central processing unit 230.

Deep learning accelerator 225 may be configured to determine whether the user's face and/or torso are at an optimal position and/or pose of a captured video or still frame, also simply referred to as a frame. The frame may be video data inside image signal processor 220 instead of frame streaming to the information handling system. In one embodiment, deep learning accelerator 225 may estimate the user's head pose and upper torso pose. Deep learning accelerator 225 may also determine whether the user is relatively in the middle or center of the frame. Further, deep learning accelerator 225 may determine whether the user is leaning in towards the camera or whether the user is leaning away from the camera. In one embodiment, deep learning accelerator 225 may have one or more Tera operations per second.

For example, deep learning accelerator 225 may determine the size and/or the ratio of the user's face relative to the frame. In addition, deep learning accelerator 225 may determine whether the user's face is within a horizontal threshold or a vertical threshold of the frame. The horizontal and vertical thresholds may be preset to a range of values. If the image of the user's face does not appear to be optimal, such that the user is not in the center of the frame, the ratio of the user's face relative to the frame is out of range, or the user does not appear to be within the horizontal and vertical thresholds, then an audible guide may be provided for the user to adjust his or her position relative to the camera. In another embodiment, adjustments may be made by the camera, such that the camera may digitally zoom in or out to resize the user's face relative to a frame. The camera may also pan from left to right or right to left to adjust the user's face and upper torso horizontally. In addition, the camera may tilt up to down or down to up to adjust the user's face or upper torso vertically.

Deep learning accelerator 225 may be configured to estimate an upper body pose and a face pose of a user based on deep learning models. Central processing unit 230 may be used by image signal processor 220 and/or deep learning accelerator 225 in performing their functions, such as during the estimate of the pose of the user's head and/or upper torso. Memory 240 may be a DDR memory that can store data associated with the present disclosure, such as calibration information and deep learning models like face detection deep learning models and pose estimation deep learning models.

In various embodiments, camera 200 may not include each of the components shown in FIG. 2. Additionally, or alternatively, camera 200 may include various additional components in addition to those that are shown in FIG. 2. Furthermore, some components that are represented as separate components in FIG. 2 may in certain embodiments instead are integrated with other components. For example, in certain embodiments, all or a portion of the functionality provided by the illustrated components may instead be provided by components integrated into one or more processor(s) as a system-on-a-chip.

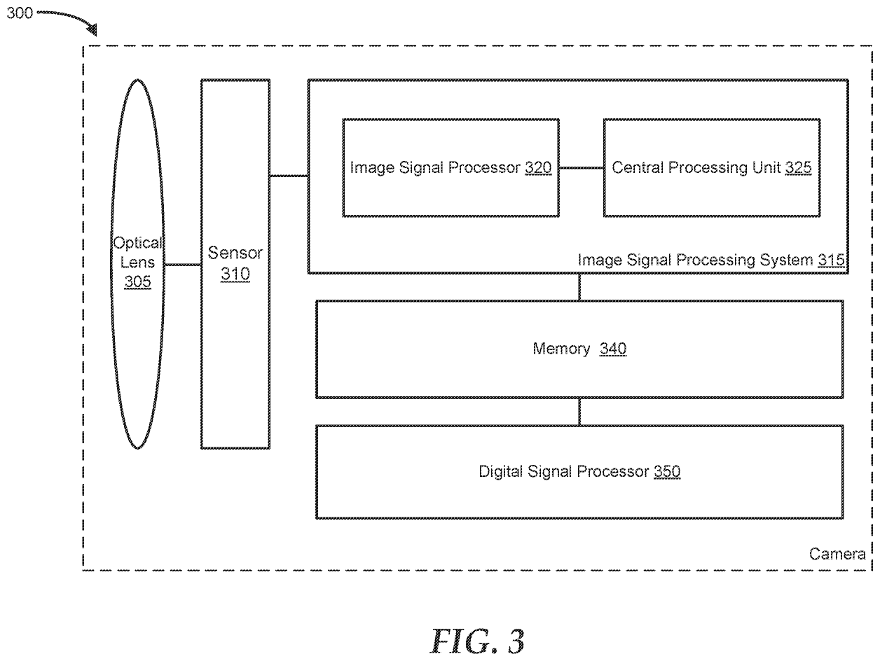

FIG. 3 shows a diagram of a camera 300 of an information handling system. Camera 300 includes an optical lens 305, a sensor 310, an image signal processing system 315, a digital signal processor 350, and a memory 340. Image signal processing system 215 includes an image signal processor 320 and a central processing unit 325. Camera 300 is similar to camera 200 of FIG. 2. Accordingly, the components of camera 300 are similar to the components of camera 200. For example, optical lens 305 may be similar to optical lens 205, sensor 310 is similar to sensor 210, memory 340 is similar to memory 240, and image signal processing system 315 is similar to image signal processing system 215. However, instead of a deep learning accelerator included in image signal processing system 315, digital signal processor 350 or a field programmable gate array configured with human presence detection functionality may be used to perform the functionality of deep learning accelerator 225. Optical lens 305 may be communicatively coupled to sensor 310 which is communicatively coupled to image signal processing system 315. Image signal processing system 315 may be communicatively coupled to digital signal processor 350 and memory 340.

Those of ordinary skill in the art will appreciate that the configuration, hardware, and/or software components of camera 200 depicted in FIG. 2, and camera 300 depicted in FIG. 3 may vary. For example, the illustrative components within camera 200 and camera 300 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

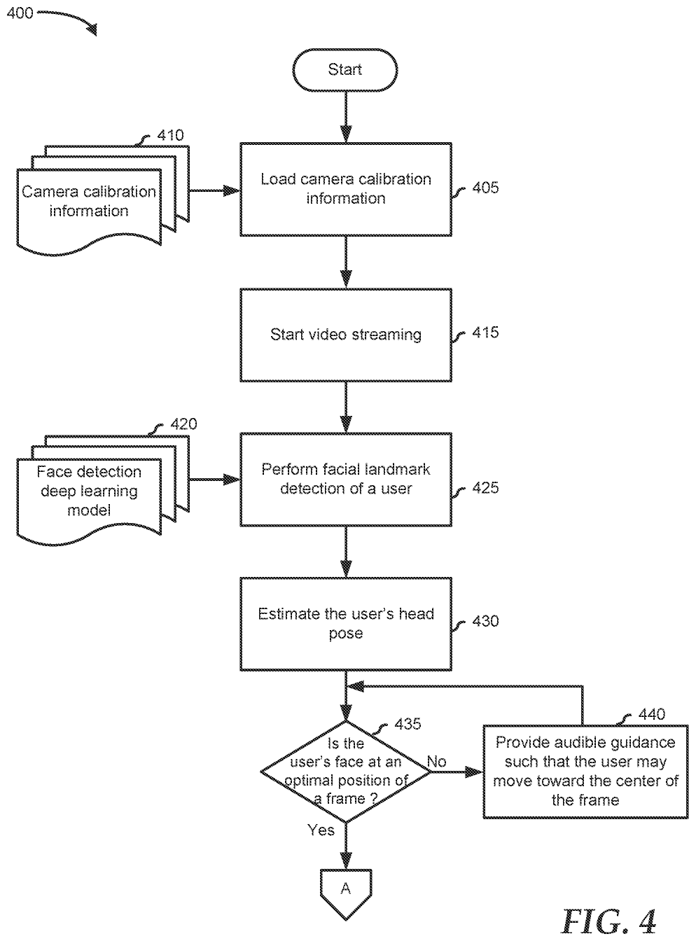

FIG. 4 shows a flowchart of a method 400 for providing audible guidance for camera users. Method 400 may be performed by one or more components of camera 200 of FIG. 2 or camera 300 of FIG. 3 prior to the start of or during the videoconference. However, while embodiments of the present disclosure are described in terms of camera 200 or camera 300, it should be recognized that other systems may be utilized to perform the described method. One of skill in the art will appreciate that this flowchart explains a typical example, which can be extended to advanced applications or services in practice.

Method 400 typically starts at block 405 where the camera may load calibration information 410, such as when the camera is turned on or at a start of a videoconference application. The calibration may be performed to adjust imaging frame parameters and recalibrate imaging functions including three-dimensional imaging operations. Calibration information 410 includes data that may be used to identify and correct distortions introduced into the image due to curvature of a lens, focal length, etc. The method may then proceed to start to transmit a video stream at block 415. The video stream may include a sequence of frames or images and may also include an audio stream. The method may proceed to block 425.

At block 425, the deep learning accelerator may run a facial detection function to detect and localize various facial landmarks, such as the eyes, mouth, nose, etc. of the user based on facial detection deep learning models 420. In one embodiment, the facial detection deep learning model 420 may be used to train the deep learning accelerator for detecting facial landmarks, which are key parts of the user's face, such as eye corners, eyebrows, nose, and mouth. The detected facial landmarks may be used in estimating the face pose of the user. The deep learning accelerator may provide a rectangular representation of the user's face as an output. The rectangular representation may include points associated with the detected facial landmarks.

The method may proceed to block 430 where the deep learning accelerator may estimate the user's head pose, such as whether the user is looking at the camera, based on the detected facial landmarks. Estimating the user's head pose may include determining one or more angles of a facial landmark relative to a horizontal and/or vertical axis associated with the frame and/or the camera's view zone. For example, a line may be drawn through points that represent the eye corners of the users. The method may then determine the angle of the line relative to the horizontal axis. Based on the angle, the method can provide an estimate of the user's head pose. The head pose may also be based on the angle of the left and/or right sides of the rectangular representation of the user's face relative to the vertical axis.

The deep learning accelerator may also determine whether the user is at an optimal position relative to the frame or the camera's view zone. For example, the deep learning accelerator may determine whether the user's face is along the middle or center of the frame relative to the borders of the frame. The user may be at an optimal location in the frame when a ratio of the user's face to the frame's size is within a threshold, such as 15% to 20% of the frame size.

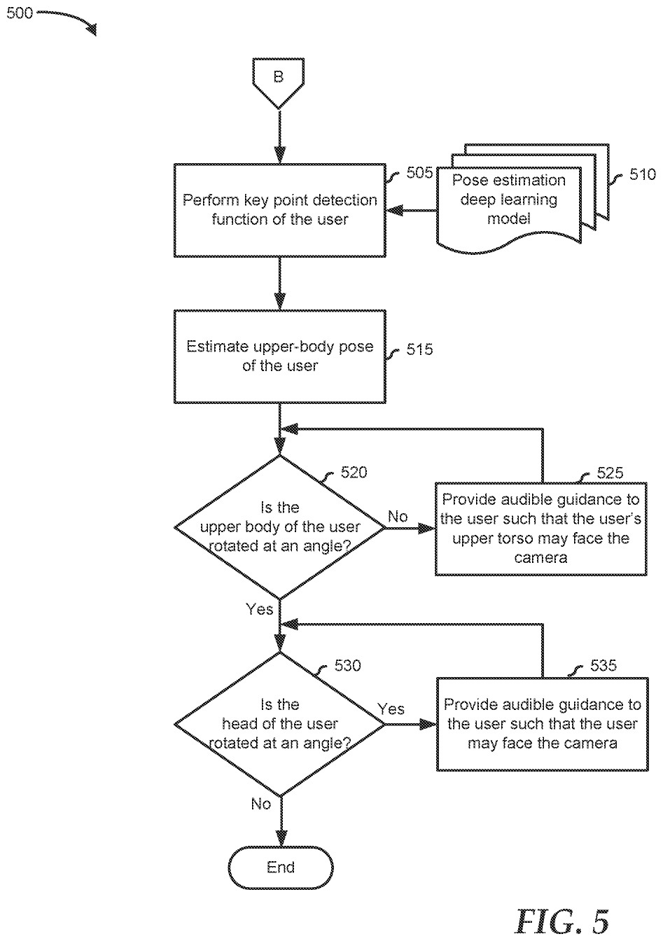

The method may then proceed to decision block 435 where the processor may determine whether the user is at an optimal position of the frame, such that the user's face is at the center or middle of the frame. If the user is at the optimal position, then the “YES” branch is taken and the method proceeds to block 505 of FIG. 5. If the user is not at the optimal position, then the “NO” branch is taken the method proceeds to block 440. At block 440, an audible guidance may be provided such that the user may move towards the center of the frame. For example, based on the user's position, the audio guidance would either ask the user to move back or move toward the camera. In another embodiment, the camera may perform various adjustments, such as zoom in or out, pan to the left or right, or tilt from top to bottom, until the user's face is around the center of the frame.

FIG. 5 shows a flowchart of a method 500 which is a continuation of method 400 of FIG. 4. Method 500 typically starts at block 505 where the deep learning accelerator may detect and localize key points on the user's upper body, also referred to herein as an upper torso, based on pose estimation deep learning models 510. In one embodiment, pose estimation deep learning models may be used to train the deep learning accelerator in detecting one or more key points or objects of the upper body of the user. The key points or objects may include upper body joints of the user, such as shoulders, elbows, wrists, etc. In one embodiment, the deep learning accelerator may then draw a skeleton of the upper torso of the user by connecting one or more of the identified key points. The method proceeds to block 515 where the deep learning accelerator may estimate an upper body pose of the user based on the detected key points. An output of the current block may include one or more angles associated with a horizontal and/or vertical axis associated with the estimation of the upper body pose of the user, such that the user's upper body is at zero degrees relative to the horizontal and/or vertical angles associated with the frame.

The method may proceed to decision block 520 where the deep learning accelerator may determine whether the user's upper body is rotated at an angle. The determination may be based on the estimate of the user's upper body pose at block 515. The rotation of the upper body may be based on the position of the user relative to a captured video frame or still image frame. The method may determine whether the user's upper torso is at zero degrees relative to a horizontal and/or vertical axis. For example, the deep learning accelerator may determine whether the user's shoulder is at zero degrees angle relative to the horizontal axis of the captured frame. If the upper body of the user is rotated at an angle, then the “YES” branch is taken and the method proceeds to decision block 530. If the upper body of the user is not rotated at an angle, then the “NO” branch is taken and the method proceeds to block 525.

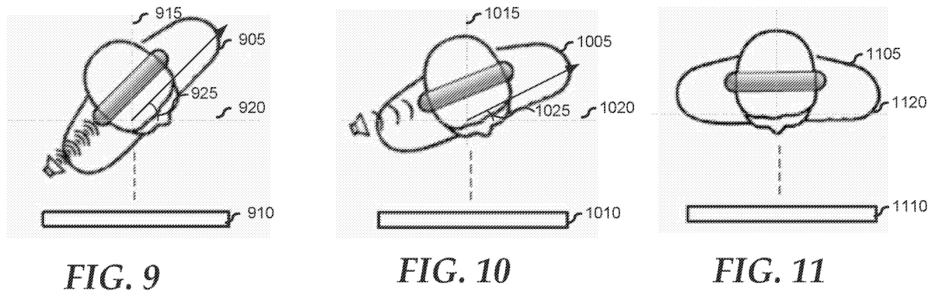

At block 525, audible guidance may be provided such that the user may move to face the camera as depicted in FIG. 9 and FIG. 10. The audible guidance may be based on adjustment information, which may be calculated based on the camera's view zone and associated x, y, and z coordinates. The calculation may also include the angle of the user's upper body relative to the frame. For example, the audible guidance may be to advise the user to move or turn the user's body to the left or the right at a certain number of degrees.

At decision block 530, the deep learning accelerator may determine whether the head of the user is rotated at an angle. The determination may be based on the estimate of the user's head pose at block 430 of FIG. 4. For example, the method may determine whether the bottom and top sides of the rectangle output are at zero degrees relative to a horizontal axis and whether the left and ride sides are at zero degrees relative to a vertical axis. If the sides of the rectangle are at an angle greater than zero degrees relative to the horizontal or vertical axis, then the head may be rotated at an angle to the right or the left. If the head of the user is rotated at an angle, then the “YES” branch is taken and the method proceeds to block 535. If the head of the user is not rotated at an angle, then the “NO” branch is taken and the method ends. At block 535, the method may provide audible guidance to the user, such that the user may face the camera. The audible guidance may be based on adjustment information, which may be calculated based on the camera's view zone and associated x, y, and z coordinates. The calculation may also include the angle of the user's face relative to the frame. For example, the audible guidance may be to advise the user to move or turn the user's head to the left or the right at a certain number of degrees, such that the user's head is at zero degrees relative to the horizontal and/or vertical angles associated with the frame.

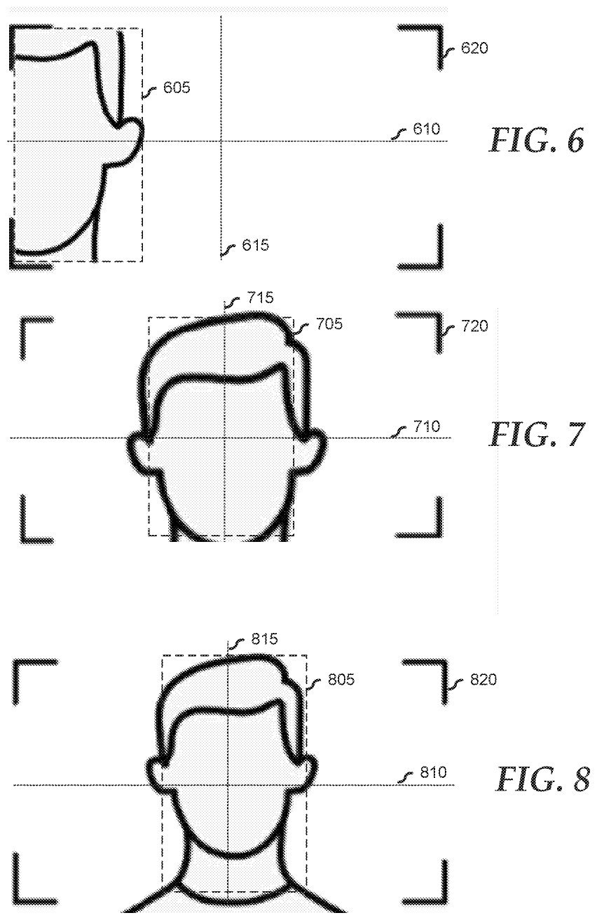

FIG. 6 shows a diagram of a full-screen view of a user of a videoconference application. In this example, the head of the user is towards one side of the screen instead of towards the center of the screen. A rectangular representation 605 of the user's face is shown relative to a horizontal axis 610 and a vertical axis 615 of a frame 620. In this scenario, an audible guide may be used to guide the user on moving toward the center of the screen. In another embodiment, the camera may pan from left to right or right to level until the user's face is towards the center of frame 620 like in FIG. 8.

FIG. 7 shows a diagram of a full-screen view of a user of a videoconference application. In this example, the head of the user is towards the center of the screen. However, based on the size of the face relative to a captured frame, the user may be too close to the camera. A rectangular representation 705 of the user's face is shown relative to a horizontal axis 710 and a vertical axis 715 of a frame 720. In this scenario, an audible guide may be used to guide the user on moving towards or away from the camera. In another embodiment, the camera may zoom in or out until the user's face is at an optimal ratio to frame 720, like in FIG. 8.

FIG. 8 shows a diagram of a full-screen view of a user of a videoconference application. In this example, the head of the user is also toward the center of the screen. Further, the size of the face of the user may be at an optimal position relative to the frame. A rectangular representation 805 of the user's face is shown relative to a horizontal axis 810 and a vertical axis 815 of a frame 820.

FIG. 9, FIG. 10, and FIG. 11 show diagrams of a top view of a user relative to a display device. In FIG. 9, the upper torso of user 905 is shown at an angle 925 relative to horizontal axis 920 and vertical axis 915 which are associated with a display device 910. In this scenario, an audible guide may be used to guide the user in moving towards or away from the camera. The loudness of the audible guide may be relative to the degree of the angle. Accordingly, as the angle is greater, the audible guide is louder. The audible guide may be heard by user 905 until the upper body pose of user 905 is facing a display device similar to a user 1105 of FIG. 11. For example, if the user is wearing a headset, the present disclosure may utilize the two-channel surround sound effect of the headset to output a beep sound from the direction that the user should be paying attention to. The larger the angle offset, the shorter the cycle of the beep sound emitted. Accordingly, the smaller the angle, the longer the cycle of the sound. The beep sound may also be based on the adjustment to be performed by the user. For example, a certain beep sound may be used to guide the user in centering the user's face within the camera view zone or frame, another beep sound may be used to guide the user in rotating the user's upper body, and yet another beep sound may be used to guide the user in rotating the user's face.

In FIG. 10, the upper torso of user 1005 is shown at an angle 1025 relative to horizontal axis 1020 and vertical axis 1015 which is associated with a display device 1010. Similar to FIG. 9, an audible guide may be used to guide the user in moving towards or away from the camera. However, this audible guide may be softer than the audible guide in FIG. 9 because angle 1025 is less than angle 925. Similar to FIG. 9, the audible guide may be heard until the upper body pose of user 1005 is facing a display device similar to a user 1105 of FIG. 11. In FIG. 11, the upper torso of user 1105 is at a zero angle relative to horizontal axis 1120 that is associated with display device 1110.

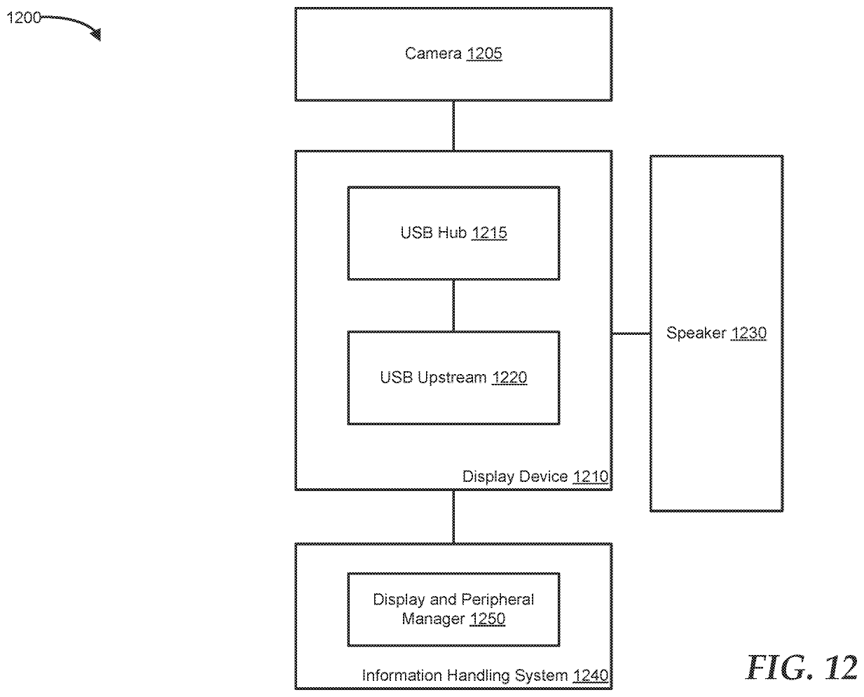

FIG. 12 shows a diagram of a system 1200 configured with audible guidance for video camera users. System 1200 includes a camera 1205, a display device 1210, a speaker 1230, and an information handling system 1240 which is similar to information handling system 100 of FIG. 1. Information handling system 1240 includes a display and peripheral manager 1250. Display and peripheral manager 1250 may be configured to manage camera 1205, display device 1210, and speaker 1230. Camera 1205 is similar to camera 200 of FIG. 2 or camera 300 of FIG. 3. In one embodiment, camera 1205 may transmit adjustment information to display and peripheral manager 1250 via USB video class extension unit, such as via USB hub 1215 which then transmits the adjustment information to USB upstream 1220. In one embodiment, camera 1205 may translate the adjustment information into a beep sound and associated information, such as which speaker(s) to be used for the beep prior to transmitting the adjustment information. The associated information may also include the length of the cycle of the beep. In another embodiment, a processor in information handling system 1240 may be configured to perform the translation of the adjustment information. Display and peripheral manager 1250 may transmit the adjustment information to speaker 1230 which provides audible guidance to a user as depicted in FIG. 4 and FIG. 5. Speaker 1230 may be an external peripheral device, integrated with camera 1205, or integrated with information handling system 1240. For example, speaker 1230 may be, a headset, a headphone, or similar.

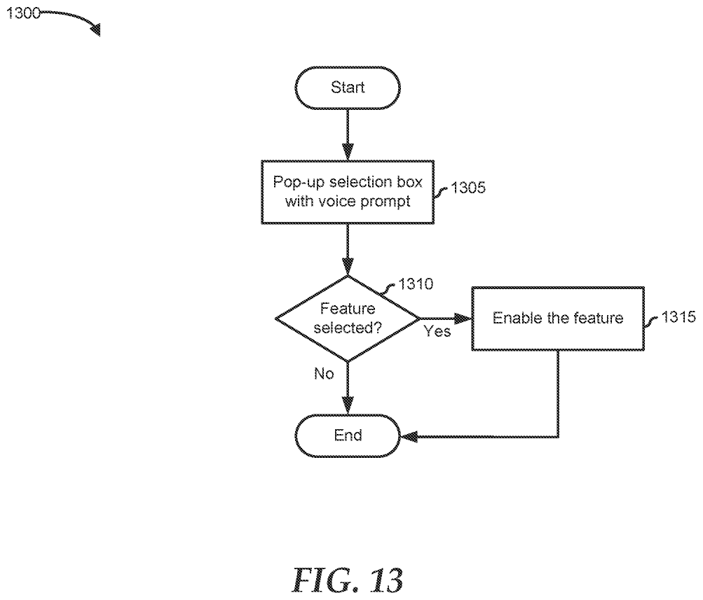

FIG. 13 shows a flowchart of a method 1300 for providing an audible guidance feature for a camera user. Method 1300 may be performed by one or more components of system 1200 of FIG. 12. Method 1300 may be performed by display and peripheral manager 1250 of FIG. 12. However, while embodiments of the present disclosure are described in terms of system 1200, it should be recognized that other systems may be utilized to perform the described method. One of skill in the art will appreciate that this flowchart explains a typical example, which can be extended to advanced applications or services in practice.

Method 1300 typically starts at block 1305 where a pop-up selection box with a voice prompt is displayed. The voice prompt may ask the user whether to enable the audible guidance feature for the user. The pop-up selection with the voice prompt may be displayed during an initial setup of the information handling system or at the start of a videoconference. However, the user may also opt to display the pop-up selection during the videoconference, such as to disable the feature. The user may opt to enable or disable the feature, such as by responding to the voice prompt or selecting one of the choices in the pop-up selection box. The method proceeds to decision block 1310 where it determines whether the audible guidance feature is selected by the user. If the feature is selected, then the “YES” branch is taken and the method proceeds to block 1315. If the feature is not selected, then the “NO” branch is taken and the method ends. At block 1315, the method may send an enable command via USB video class extension unit protocol.

Although FIG. 4, FIG. 5, and FIG. 13 show example blocks of method 400, method 500, and method 1300, some implementations of method 400, method 500, and method 1300 may include additional blocks, fewer blocks, different blocks, or differently arranged blocks than those depicted in FIG. 4, FIG. 5, and FIG. 13. Those skilled in the art will understand that the principles presented herein may be implemented in any suitably arranged processing system. Additionally, or alternatively, two or more of the blocks of method 400, method 500, and method 1300 may be performed in parallel. For example, block 425 of method 400 and block 515 of method 500 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
detecting, by a processor, facial landmarks of a user based on a face detection learning model;
estimating a head pose of the user based on the detected facial landmarks, wherein the head pose is relative to a frame;
determining adjustment information based on the head pose of the user; and
if the head pose of the user is rotated at an angle, then providing audible guidance based on the adjustment information.

2. The method of claim 1, further comprising detecting key points associated with an upper body of the user.

3. The method of claim 2, further comprising estimating an upper body pose of the user based on the detected key points.

4. The method of claim 3, further comprising if the upper body of the user is rotated, then providing another audible guidance to the user.

5. The method of claim 1, wherein the audible guidance is to turn a certain number of degrees.

6. The method of claim 1, wherein the audible guidance is a beeping sound.

7. The method of claim 6, wherein loudness of the beeping sound is based on the angle.

8. An information handling system, comprising:
a processor; and
a memory storing code that when executed causes the processor to perform operations including:
detecting facial landmarks of a user based on a face detection learning model;
estimating a head pose of the user based on the detected facial landmarks;
determining adjustment information based on the head pose of the user; and
if the head pose of the user is rotated at an angle, then providing audible guidance based on the adjustment information.

9. The information handling system of claim 8, wherein the operations further comprise detecting key points associated with an upper body of the user.

10. The information handling system of claim 9, wherein the operations further comprise estimating an upper body pose of the user based on the detected key points.

11. The information handling system of claim 10, wherein if the upper body pose of the user is rotated, then providing another audible guidance to the user to turn a number of degrees.

12. The information handling system of claim 8, wherein the adjustment information includes a number of degrees for the user to turn.

13. The information handling system of claim 8, wherein the audible guidance is a beeping sound.

14. The information handling system of claim 13, wherein loudness of the beeping sound is based on the angle.

15. A non-transitory computer-readable medium to store instructions that are executable to perform operations comprising:
detecting facial landmarks of a user based on a face detection learning model;
estimating a head pose of the user based on the detected facial landmarks;
determining adjustment information based on the head pose of the user; and
if the head pose of the user is rotated at an angle, then providing audible guidance based on the adjustment information.

16. The non-transitory computer-readable medium of claim 15, wherein the operations further comprise detecting key points associated with an upper body of the user.

17. The non-transitory computer-readable medium of claim 16, wherein the operations further comprise estimating an upper body pose of the user based on the detected key points.

18. The non-transitory computer-readable medium of claim 17, wherein if the upper body pose of the user is rotated, then providing another audible guidance to the user to turn a number of degrees.

19. The non-transitory computer-readable medium of claim 15, wherein the audible guidance is a beeping sound.
